(19) United States
(12) Patent Application Publication
(10) Pub. No.: US 2025/0051190 A1
(43) Pub. Date: Feb. 13, 2025

(54) CONTROL SYSTEMS FOR UV WATER TREATMENT REACTOR

(71) Applicant: TROJAN TECHNOLOGIES GROUP ULC, London (CA)

(72) Inventor: John VAREKA, London (CA)

(73) Assignee: TROJAN TECHNOLOGIES GROUP ULC, London (CA)

(21) Appl. No.: 18/798,135

(22) Filed: Aug. 8, 2024

Related U.S. Application Data
(60) Provisional application No. 63/531,704, filed on Aug. 9, 2023.

(51) Int. Cl. C02F 1/32

(52) U.S. Cl. CPC C02F 1/32; C02F 2201/326; C02F 2209/02; C02F 2209/40

(57) ABSTRACT

Methods of operating a system for treating a fluid flowing through a reactor with ultraviolet (UV) light emitted from a light source assembly. One method includes detecting, with a flow sensor, a flow rate of fluid through the reactor; and controlling, with a processor, electric power supplied to the light source assembly so that a low average amount of electric power is supplied when the flow rate is below a threshold. In another method, an intensity of the UV light may be controlled by the processor based on a detected temperature in the light source assembly. Yet another method includes determining that the flow sensor is defective based on the detected temperature in the light source assembly and the detected flow rate. A further method includes determining that an intensity sensor is defective based on a detected intensity and the detected temperature in the light source assembly.

### CROSS-REFERENCE TO RELATED APPLICATIONS

This application claims priority to Provisional Application No. 63/531,704, filed Aug. 9, 2023. The content of the prior application is hereby incorporated by reference herein in its entirety.

### TECHNICAL FIELD

This application relates to systems and methods for treating fluids with ultraviolet light.

### BACKGROUND

The proper disinfection of water is critical to ensure water quality. As the need for cleaner sources of water has increased, water disinfection methods have evolved to match the rising challenge. Water sources may contain heavy metals, sediment, chemicals, pesticides, or the like. Water sources may also contain pathogens such as microorganisms, viruses, or the like. Left untreated, such water may be unhealthy or unsafe for use by humans or animals. Ultraviolet light treatment of water may be used to inactivate pathogens. Water may pass through a small chamber or a larger vessel where the water is subjected to ultraviolet light. The ultraviolet treatment may damage nucleic acids of the pathogens making the pathogens incapable of performing vital cellular functions, thereby rendering them harmless. Thus, this ultraviolet treatment process may make water potable despite the water source containing microorganisms, viruses, or the like.

Residential ultraviolet reactor vessels modulate an amount of power sent to produce the ultraviolet light based on the amount of flow traveling through the chamber. A flow sensor may be used to detect the flow rate of the fluid traveling through the reactor vessel and if the flow sensor malfunctions, the flow sensor will improperly indicate that fluid is not flowing. If the flow sensor improperly indicates that fluid is not flowing through the reactor vessel, the system will not increase the amount of power sent to the ultraviolet light, thereby causing a risk that untreated flow will reach the consumer and cause potential harm.

In addition, when using a flow sensor to modulate disinfection power as a function of flow rate, there is a detection limit, that is, a flow rate below which the flow sensor does not respond. Further, even if the flow through the reactor vessel is stagnant, i.e., there is no flow, stagnant water may remain in the reactor vessel without treatment for an extended time period, which may provide enough time for the above-mentioned organic contaminants to reproduce, thereby creating a risk that the water becomes dangerous to consume. Furthermore, when there is no flow, upstream untreated water may contain contaminants that can diffuse along the flow path. The diffusion of contaminants may result in contaminants traveling into the reactor vessel or past the reactor vessel and into the downstream water supply. This diffusion of contaminants may thus cause a risk that untreated water is delivered to the user when the flow continues.

There is a need for a system that can avoid potential contamination due to malfunctioning sensors and/or detection limits of the sensors.

### SUMMARY

These and other problems are addressed by the disclosed methods for operating a system for treating a fluid that flows through a reactor and is exposed to ultraviolet (UV) light emitted from a UV light source assembly.

One such method includes: detecting, with at least one temperature sensor, a temperature in the UV light source assembly; and controlling, with at least one processor, an intensity of the UV light based on the detected temperature from the at least one temperature sensor.

Another method includes: detecting, with at least one temperature sensor, a temperature in the UV light source assembly; detecting, with a flow sensor, a flow rate of the fluid through the reactor; and determining, by at least one processor, that the flow sensor is defective based on the detected temperature and the detected flow rate.

Yet another method may include: detecting, with an intensity sensor, an intensity of UV light emitted by the UV light source assembly; detecting, with a temperature sensor, a temperature in the UV light source assembly; and determining, by at least one processor, that the intensity sensor is defective based on the detected intensity of UV light and the detected temperature in the UV light source assembly.

A further method may include: detecting, with a flow sensor, a flow rate of the fluid through the reactor; and controlling, with at least one processor, electric power supplied to the UV light source assembly so that: (i) an amount of the electric power is adjusted based on the detected flow rate in a first state in which the detected flow rate is greater than or equal to a threshold flow rate, and (ii) a low average amount of electric power is supplied to the UV light source assembly in a second state in which the detected flow rate is below the threshold flow rate. The low average amount of electric power in the second state has a non-zero value that is not based on the detected flow rate and is lower than the amount of electric power supplied in the first state over a given time.

### BRIEF DESCRIPTION OF THE OF THE DRAWINGS

FIG. 1 shows a perspective view of a fluid treatment system.

FIG. 2 is a cross-sectional view of the fluid treatment system.

FIG. 3 shows a perspective view of a reactor.

FIGS. 4A and 4B are perspective views illustrating a light source assembly.

FIG. 5 is a perspective view illustrating a light source unit.

FIG. 6 is an exploded perspective view illustrating the light source unit.

### DETAILED DESCRIPTION

In the following description, numerous details are set forth to provide an understanding of the present disclosure. However, it may be understood by those skilled in the art that the systems and methods of the present disclosure may be practiced without these details and that numerous variations or modifications from the described embodiments may be possible.

Disclosed herein are fluid treatment systems and methods of operating a system for treating a fluid that flows through a reactor and is exposed to UV light emitted from a UV light source assembly.

### Fluid Treatment System

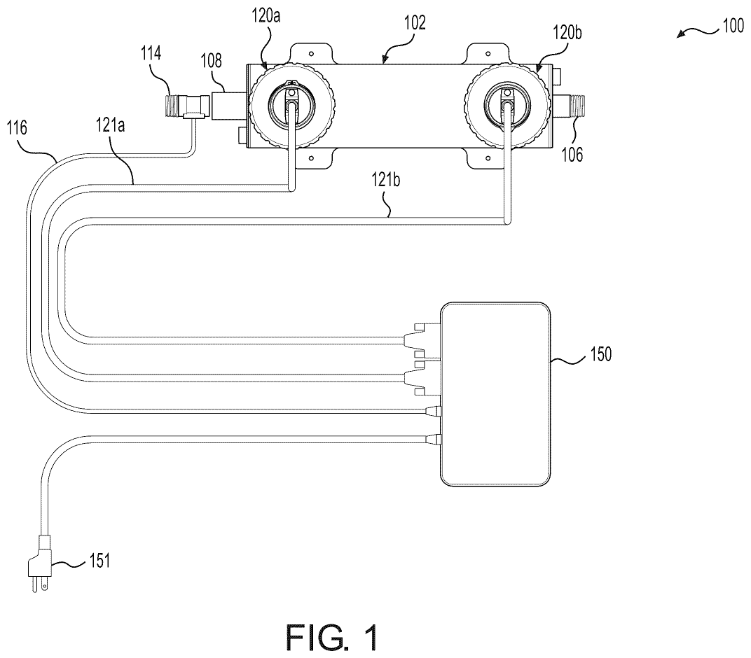

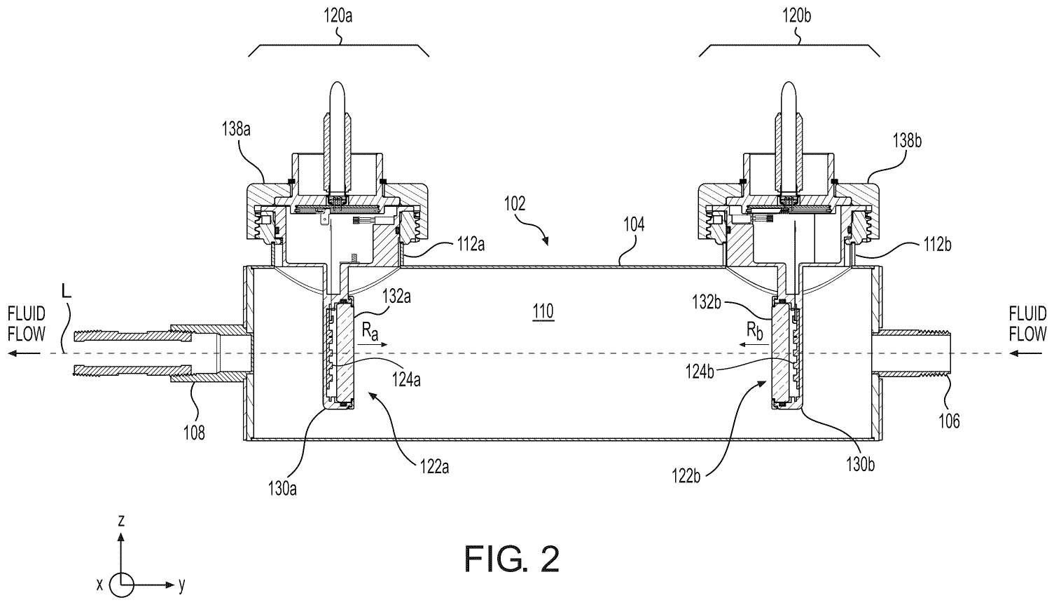

FIG. 1 shows a perspective top view of an exemplary fluid treatment system 100, and FIG. 2 is a cross-sectional view of the fluid treatment system. As shown in FIGS. 1 and 2, the treatment system 100 includes a reactor 102 including a treatment chamber 110 for receiving a flow of fluid for UV radiation treatment. The treatment chamber 110 extends along a longitudinal axis L and includes an inlet 106 through which fluid is introduced into the treatment chamber 110 and an outlet 108 through which the fluid is discharged from the chamber 110 after being treated. The longitudinal axis L may substantially coincide with a longitudinal axis of the reactor 102. The inlet 106 and the outlet 108 are in fluid communication with the treatment chamber 110, and the fluid may flow within the treatment chamber 110 from the inlet 106 to the outlet 108 generally along the longitudinal axis L of the treatment chamber. For example, the inlet 106 and the outlet 108 may be arranged on opposite sides of the treatment chamber 110 along the longitudinal axis L. However, the present disclosure is not limited to this arrangement, and the inlet 106 and the outlet 108 may be arranged in any suitable manner.

Referring to FIG. 1, the fluid treatment system 100 may further include a processor 150 that is connected to a power source, such as an electrical grid, via the plug 151. As discussed in more detail below, the processor 150 may be configured to control the functioning and/or operation of the treatment system 100 and/or evaluate a condition of the treatment system 100 and/or components thereof, including determining whether one or more components are defective, based on measurements received from one or more sensors including, for example, one or more temperature sensors 126, a flow sensor 114, one or more intensity sensors 127, and the like.

In one embodiment, the fluid treatment system 100 may be a residential system for disinfecting water for household use. The system 100 may be installed between a water source, such as a well or municipal water facility, and the household piping. For example, the system 100 may installed at a point of entry of the water into the household piping. The system 100 can be integrated into existing piping for treating the fluid flowing through the piping. For example, the inlet 106 and the outlet 108 may be coupled to the piping for providing in-line flow and a simple connection to the piping without using an L-shape or elbow pipe connector. The system 100 may be installed so as to be integrated with the household piping in the basement of a home at a position where the water flowing from external piping in fluid communication with a well or water treatment facility enters the home. The inlet 106 may receive water flowing from the water source, the treatment chamber may treat the water with UV radiation, making the water safe for use, and the outlet 108 may deliver the treated water to downstream household piping for household use. For residential systems, the treatment chamber 110 can have a volume that is in a range of about 0.25 L to 10 L, from 0.5 L to 5 L, or from 1 L to 3 L, for example. The reactor 102 may be designed for a flow of fluid, such as water or other aqueous fluids, through the treatment chamber 110 at a flow rate in a range of 1 to 25 gallons per minute (gpm), 5 to 20 gpm, or 10 to 15 gpm. Of course, at times, the fluid in the reactor 102 may be substantially stagnant, in which case the flow rate may be less than 1 gpm, less than 0.5 gpm, or less than 0.25 gpm.

The treatment system 100 includes first and second light source assemblies 120a, 120b that may be removably coupled to the reactor 102. The first and second light source assemblies 120a, 120b respectively include first and second light source units 122a, 122b that are arranged inside the treatment chamber 110 to treat the fluid flowing through the chamber 110 with UV radiation for disinfection, purification, sterilization, or the like. The first and second light source units 122a, 122b may be arranged in the treatment chamber 110 so as to be opposed to each other along the longitudinal axis L of the treatment chamber 110. However, the present disclosure is not limited to this arrangement, and the first and second light source units 122a, 122b may be arranged in any suitable manner. The first and second light source units 122a, 122b respectively include first and second arrays of UV LEDs 124a, 124b that are configured to emit UV radiation inside the treatment chamber 110 of the reactor 102. The first and second arrays of LEDs 124a, 124b may emit light in the UV spectrum, for example, in a wavelength band of about 100 nm to about 405 nm, a wavelength band of about 140 to about 330 nm, or a wavelength band of about 180 nm to about 280 nm. The UV light in the above wavelength bands has high germicidal efficacy and may kill at least 99% of microorganisms, such as bacteria, fungi, viruses, mold, and the like, in the fluid, making the fluid safe for use and consumption. The LEDs 124a, 124b may have an efficiency in converting electrical energy to UV light energy in a range of about 3% to about 30%, a range of about 4% to about 15%, or a range of about 5% to about 10%. The reactor may be designed to deliver a UV dose of 5 mJ/cm2 to 100 mJ/cm2, or about 30mJ/cm2, to the fluid at the target flow rate and target water quality, or may be designed to deliver any other suitable UV dose to the fluid.

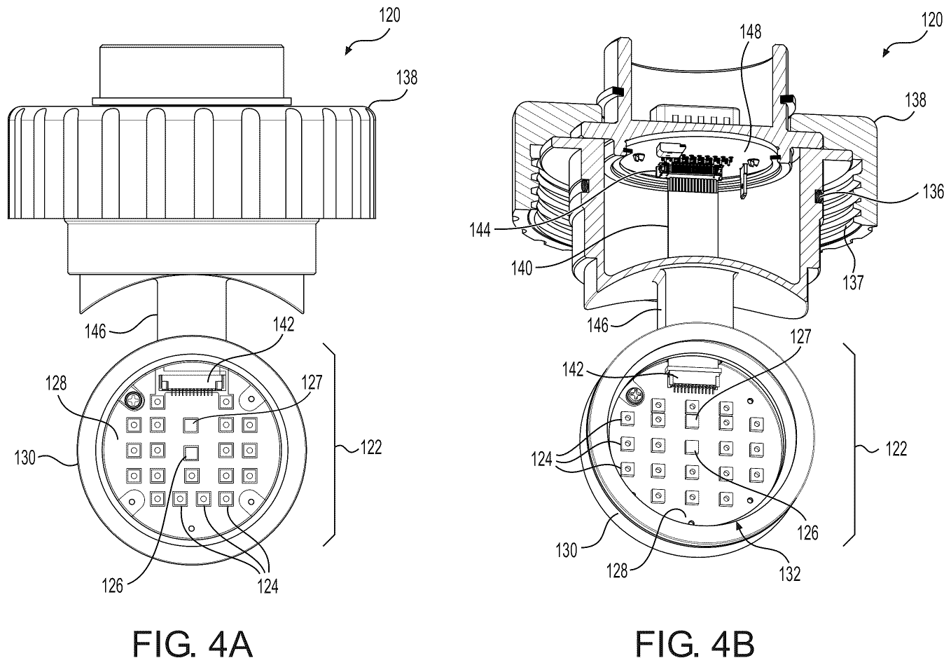

As shown in FIG. 2, the first and second light source units 122a, 122b may respectively include a first housing 130a and a second housing 130b in which the first and second arrays of LEDs 124a, 124b are respectively arranged. The first and second housings 130a, 130b may further respectively include first and second UV transparent windows 132a, 132b that are arranged to cover the first and second arrays of LEDs 124a, 124b, respectively. The UV transparent windows 132a, 132b may secured in the housing 130a, 130b via O-ring 134a, 134b. Details regarding the first and second light source units 122a, 122b will be discussed further with respect to FIGS. 4A-6.

In FIGS. 1 and 2, the “y” direction is parallel to the longitudinal axis L of the treatment chamber 110 and the direction of fluid flow through the treatment chamber 110 between the inlet 106 and the outlet 108. The “x” and “z” directions are radial directions of the reactor vessel 102, where the “z” direction is parallel to an insertion/removal direction of the light source units 122a, 122b into the treatment chamber 110 of the reactor vessel 102.

The first and second light source assemblies 120a, 120b further include first and second caps 138a, 138b that are arranged outside of the reactor 102 and removably coupled to first and second lateral ports 112a, 112b formed in the outer wall 104 of the reactor 102 to support the light source units 122a, 122b suspended inside the treatment chamber 110. As shown in FIG. 2, the light source assemblies 120a, 120b can be removably coupled to the reactor 102 by inserting the light source units 122a, 122b into the treatment chamber 110 through a respective lateral opening in the ports 112a, 112b of the reactor 102 in a direction (e.g., the Z direction) transverse to the longitudinal axis L, and coupling the caps 138a, 138b to the ports 112a, 112b of the reactor 102. Likewise, the light source assemblies 120a, 120b can be uncoupled from the reactor 102 by uncoupling the caps 138a, 138b from the ports 112a, 112b and removing the light source units 122a, 122b from the treatment chamber 110 of the reactor 102 in a direction (e.g., the Z direction) transverse to the longitudinal axis L. Although in FIG. 2 the light source units 122a, 122b are inserted into and removable from the treatment chamber 110 along the Z direction, which is orthogonal (e.g., at an angle of about 90°) to the longitudinal axis L of the treatment chamber 110, the present disclose is not limited to this arrangement. The light source units 122a, 122b may be inserted into and removed from the treatment chamber 110 by movement along any suitable direction, including, for example, a direction parallel to the longitudinal axis L of the treatment chamber 110, or a direction at any suitable angle transverse to the longitudinal axis L of the treatment chamber 110, such as an angle in a range of 20° to 160°, a range of 30° to 150°, or a range of 45° to 135°.

During use, the light source unit 122 of the light source assembly 120 may periodically become fouled with foreign materials, which can inhibit its ability to transmit the UV radiation to the fluid. Once fouling has reached a certain point, the light source unit 122 may be cleaned to remove the fouling materials and optimize the system. By arranging the light source assembly 120 to be insertable and removable along a direction transverse to the longitudinal axis L of the treatment chamber 110, the light source assembly 120 can be easily removed from the reactor 102 without disturbing the piping connection for cleaning to remove fouling materials from the light source unit 122, as well as for other routine maintenance or servicing. This is particularly advantageous when the system is installed in existing household piping, where there may be limited space.

As shown in FIG. 2, the first and second light source assemblies 120a, 120b are removably coupled to the reactor 102 via the caps 138a, 138b such that the first and second light source units 122a, 122b are arranged inside the treatment chamber 110 and are oriented for directing UV radiation into the fluid flowing through the treatment chamber 110. In the example shown in FIG. 2, the light source units 122a, 122b are concentric with the chamber 110 and are orthogonal to both the longitudinal axis L of the treatment chamber 110 and the direction of fluid flow (along the Y direction) through the treatment chamber 110 between the inlet 106 and the outlet 108. However, the present disclosure is not limited to this, and the light source units 122a, 122b can be arranged in any suitable orientation for sufficiently treating the fluid flowing through the treatment chamber 110 with UV radiation. The light source units 122a, 122b may be oriented so that a plane of the UV transparent windows 132a, 132b and/or a plane of the backside (i.e., non-emitting side) of the housing 130a, 130b is transverse or orthogonal to the longitudinal axis of the reactor 102 and/or is transverse or orthogonal to a direction of fluid flow through the treatment chamber 110. For example, the plane of the windows 132a, 132b and/or the plane backside of the light source units 122a, 122b may be oriented at any suitable angle transverse to the longitudinal axis L of the treatment chamber 110, such as an angle in a range of 20° to 160°, a range of 30° to 150°, or a range of 45° to 135°. The plane of the windows 132a, 132b and/or the plane backside of the light source unit 122a, 122b may additionally or alternatively be transverse or orthogonal to the direction of fluid flow through the treatment chamber 110 so as to be oriented at an angle with respect to the direction of fluid flow in a range of 20° to 160°, a range of 30° to 150°, or a range of 45° to 135°.

Similarly, the first and second arrays of LEDs 124a, 124b may be arranged in a plane that is transverse or orthogonal to the longitudinal axis L of the reactor 102 and/or is transverse or orthogonal to a direction of the fluid flow through the treatment chamber 110. The plane of the first and second arrays of LEDs 124a, 124b may be oriented at any suitable angle transverse to the longitudinal axis L of the treatment chamber 110, such as an angle in a range of 20° to 160°, a range of 30° to 150°, or a range of 45° to 135°. The LED arrays 124a, 124b may additionally or alternatively be transverse or orthogonal to the direction of fluid flow through the treatment chamber 110 so as to be oriented at an angle with respect to the direction of fluid flow in a range of 20° to 160°, a range of 30° to 150°, or a range of 45° to 135°.

The first and second light source assemblies 120a, 120b can be arranged so that the first and second arrays of LEDs 124a, 124b face each other inside the treatment chamber 110. For example, in this context, “face” may mean the first and second light source units 122a, 122b are arranged so that the beams of UV radiation from the first and second arrays of LEDs 124a, 124b at least partially overlap each other. For instance, the light-emitting sides of the light source units 122a, 122b (i.e., the sides through which UV light passes, e.g., on the sides of the UV transparent windows 132a, 132b) may be directly opposed to each other at a normal angle, offset with respect to each other along the longitudinal axis L or other direction, or angled with respect to each other, as discussed in more detail below.

In the embodiment shown in FIG. 2, the first and second light source assemblies 120a, 120b are arranged so that the main directions of the radiation beams emitted by the first and second arrays of LEDs 124a, 124b are along arrows Rₐ and R_{b} towards each other. In particular, the first light source assembly 120a is arranged so that the first array of LEDs 124a emits UV radiation generally in the direction Rₐ toward the second light source unit 122b, whereas a back side of the first light source unit 122a faces the outlet 108, and the second light source assembly 120b is arranged so that the second array of LEDs 124b of the second light source unit 122b emits UV radiation generally in the direction R_{b} toward the first light source unit 122a, whereas a backside of the second light source unit 122b faces the inlet 106. In FIG. 2, the UV LED arrays 124a, 124b are each arranged in a plane orthogonal to the longitudinal axis L and the LED arrays 124a, 124b are directly opposed to each other along the longitudinal axis L so that the main directions Rₐ and R_{b} of the beams of radiation are generally parallel to and/or coincident with the longitudinal axis L. However, the present disclosure is not limited to this arrangement, and the first and second light source assemblies 120a, 120b may be arranged in any suitable manner so that the beams of radiation from the first and second arrays of LEDs 124a, 124b at least partially overlap each other.

For example, in another embodiment, the light-emitting sides of the light source units 122a, 122b may face each other (e.g., be directly opposed) along a direction transverse to the longitudinal axis L, such as a direction at an angle in a range of 20 to 160°, a range of 30° to 150°, or a range of 45° to 135° from the longitudinal axis L. In this case, a direction extending between the light-emitting sides of the first and second light source units 122a, 122b and normal to the planes of the first and second LED arrays 124a, 124b is transverse to the longitudinal axis L, such as at an angle in one of the above ranges.

Alternatively or additionally, the first and second light source assemblies 120a, 120b may be arranged so that the light-emitting sides directly face (e.g., oppose) each other but the light source units 122a, 122b are offset from each other. For example, one or both of the light source units 122a, 122b may be offset from the longitudinal axis or each other in a radial or width direction of the reactor 102 (e.g., in a direction transverse to the longitudinal axis L) so that the beams of UV radiation emitted from the light source units 122a, 122b only partially overlap. In such an arrangement, a center of the first LED array 124a may not be aligned with a center of the second LED array 124a, and the center of one or both of the LED arrays 124a, 124b may be offset from the longitudinal axis and/or offset from each other.

In the above embodiments, the first and second light source assemblies 120a, 120b may be arranged so that the planes of the first and second LED arrays 124a, 124b are generally parallel to each other. However, the present disclosure is not limited to this arrangement, and the first and second light source assemblies 120a, 120b may be arranged so that the planes of the LED arrays 124a, 124b are angled with respect to each other. For example, the planes of the LED arrays 124a, 124b may be angled with respect to each other, for example, at an angle in a range of 5 to 175°, a range of 20° to 150°, or a range of 45° to 135°, or any other suitable angle.

By arranging the first and second light source assemblies 120a, 120b so that the first and second arrays of LEDs 124a, 124b face each other (e.g., such that the beams of UV radiation at least partially overlap each other), the time that the fluid is exposed to the UV radiation can be extended. This can ensure that the fluid flowing through the treatment chamber is sufficiently irradiated with UV radiation for disinfecting the fluid to make it safe for use and consumption. For example, by arranging the first and second light source assemblies 120a, 120b so that the first and second arrays of LEDs 124a, 124b face each other, and emit UV radiation in the main directions Rₐ, R_{b} towards each other generally along the longitudinal axis L of the treatment chamber 110 and/or the direction of fluid flow, the fluid flowing through the chamber 110 can be irradiated with UV light along substantially the entire length of the chamber 110 or along substantially most of or a majority of the length of the chamber 110.

Continuing to refer to FIG. 2, the light source units 122a, 122b are arranged in the treatment chamber 110 so as to be immersed in the fluid flowing through the treatment chamber 110 for UV treatment. In other words, the fluid flowing through the treatment chamber 110 impinges on and flows around the light source units 122a, 122b. The fluid may not only impinge on and flow around the front, light-emitting side of the light source units 122a, 122b, but may also impinge on and flow around the back side of the light source units 122a, 122b, where considerable heat is often generated. Thus, the fluid being treated can be used to continuously cool the light source units 122a, 122b.

Although FIGS. 1 and 2 show an exemplary fluid treatment system 100 including two light source assemblies 120a, 120b, the present disclosure is not limited to any particular number of light source assemblies so long as the number of light source assemblies is sufficient to disinfect the fluid. The number of light source assemblies 120 may be determined based on the flow rate and/or level of disinfection. For example, the treatment system 100 may include any suitable number of light source assemblies for disinfecting the fluid, such as at least one, at least two, or at least three light source assemblies, and up to twenty light source assemblies, up to ten light source assemblies, or up to five light source assemblies.

The fluid treatment system 100 may further include a flow sensor 114 for measuring a flow rate of the fluid flowing through the reactor 102. As shown in FIGS. 1 and 2, the flow sensor 114 may be integrated in the outlet 108. Alternatively, the flow sensor 114 may be integrated in the inlet 106 or inside the treatment chamber 110, or any other suitable location for detecting the flow rate of the fluid through the chamber 110. The flow sensor 114 may be a mass flow meter or any other suitable flow sensor for detecting the flow rate of fluid through the reactor 102. With reference to FIG. 1, the processor 150 may control the flow sensor 114 to measure the flow rate of fluid flowing through the treatment chamber 110 and the flow sensor 114 may transmit the measured flow rate to the processor 150. As discussed in more detail below, the processor 150 may be configured to use the measured flow rate to control UV LED power.

The fluid treatment system 100 may further include any other suitable temperature sensor, such as a fluid temperature sensor for measuring the temperature of the fluid flowing through the reactor 102. For example, the fluid temperature sensor may be a thermometer and/or may include a probe protruding into the fluid flow through the treatment chamber 110. As discussed in more detail below, the light source assembly 120 may include a temperature sensor 126 for measuring a temperature of the light source assembly and/or an intensity sensor 127. Alternatively, the intensity sensor 127 may be arranged in the reactor 102 outside of the light source assembly 120.

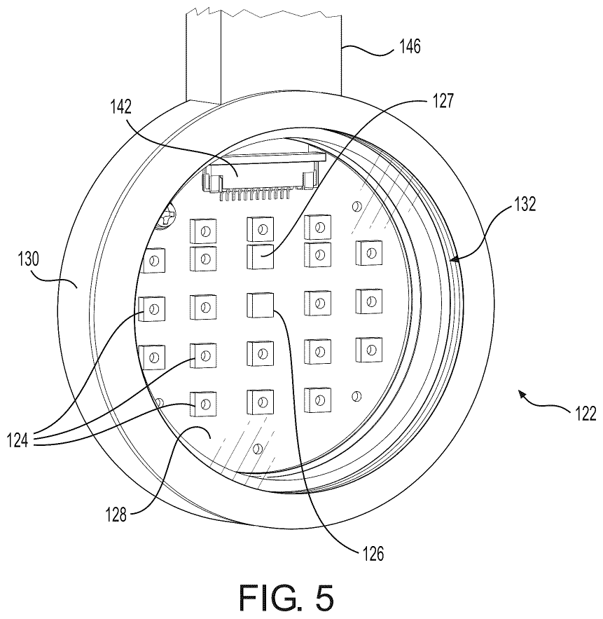

Referring to FIG. 1, the processor 150 is connected to a power source, such as an electrical grid, via the plug 151. The processor 150 may be configured to control the transmission of electrical power to the system 100. For instance, the processor 150 may transmit power from the electrical grid to each of the light source assemblies 120a, 120b via cables 121a, 121b for powering the arrays of LEDs 124a, 124b and any sensors, such as a temperature sensor 126 or an intensity sensor 127 (shown in FIGS. 4A-5) housed within the light source assemblies 120a, 120b. The temperature and intensity sensors 126, 127 are discussed in more detail below. Similarly, the processor 150 may transmit power from the electrical grid to the flow sensor 114 via cable 116. The processor 150 may also control the transmission of electrical power to any other components and/or sensor arranged in the fluid treatment system 100, such as a fluid temperature sensor for measuring the temperature of the fluid flowing through the reactor 102.

The processor 150 may be configured to control the functioning of the system 100 based on measurements received from one or more sensors, including, for example, the flow sensor 114, the temperature sensor 16, the intensity sensor 127, the fluid temperature sensor (not shown), and any other sensor, according to the methods described below. For instance, the processor 150 may control the flow sensor 114 to periodically measure the flow rate of fluid flowing through the treatment chamber 110. The flow sensor 114 may transmit the measured flow rate to the processor 150. The processor 150 may use the measured flow rate to modulate power supplied to the light source assemblies 120a, 120b.

The processor 150 includes hardware, such as a circuit for processing digital signals and a circuit for processing analog signals, for example. The processor 150 may include one or a plurality of circuit devices (e.g., an IC) or one or a plurality of circuit elements (e.g., a resistor, a capacitor) on a circuit board, for example. The processor 150 may be a central processing unit (CPU) or any other suitable processor or controller. The processor 150 may be or form part of a specialized or general purpose computer or processing system. One or more controllers, processors, or processing units, memory, and a bus that operatively couples various components, including the memory to the processor, may be used. The processor 150 may include a module that performs the methods described herein. The module may be programmed into the integrated circuits of the processor, or loaded from memory, storage device, or network or combinations thereof. For example, the processor 150 may execute operating and other system instructions, along with software algorithms, machine learning algorithms, computer-executable instructions, and processing functions of the fluid treatment system.

The processor 150 may be operational with numerous other general purpose or special purpose computing system environments or configurations. Examples of well-known computing systems, environments, and/or configurations that may be suitable for use with the disclosed embodiments may include, but are not limited to, personal computer systems, server computer systems, thin clients, thick clients, handheld devices, such as tablets and mobile devices, laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The present disclosure further relates to a non-transitory computer-readable storage medium configured to store a computer-executable program that causes a computer to perform functions, such as those for implementing the methods disclosed herein. The computer-readable storage medium may further store the real time data collected by the processor 150 and computer-executable instructions. The storage medium may include a memory and/or any other storage device. The memory may be, for example, random-access memory (RAM) of a computer. The memory may be a semiconductor memory such as an SRAM and a DRAM. The storage device may be, for example, a register, a magnetic storage device such as a hard disk device, an optical storage device such as an optical disk device, an internal or external hard drive, a server, a solid-state storage device, CD-ROM, DVD, other optical or magnetic disk storage, or other storage devices.

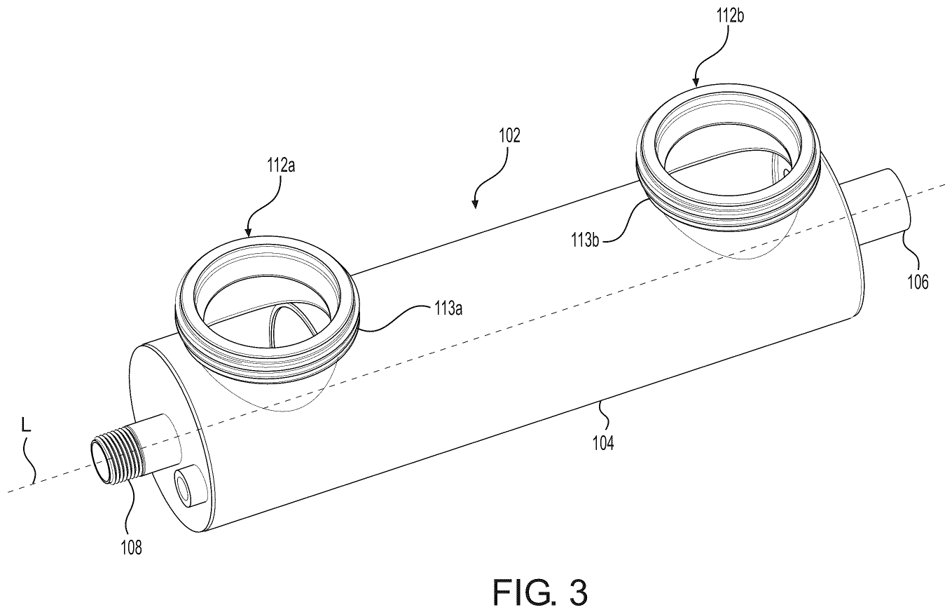

Referring to FIG. 3, the reactor 102 may be a vessel having a substantially cylindrical body defined by an outer wall 104. For example, the reactor 102 may have a circular cross-sectional shape, as shown in FIG. 3. However, the present disclosure is not limited to any particular cross-sectional shape, and the reactor 102 may have various other cross-sectional shapes, for example, an elliptical shape, a polygonal shape including, for example, a square or rectangular shape, and a semicircular shape. For residential systems, the reactor 102 may have a length, in a direction along the longitudinal axis L from the inlet 106 to the outlet 108, in a range of 100 mm to 1,000 mm, 200 mm to 500 mm, or 240 mm to 350 mm. The treatment chamber 110 of the reactor 102 may have a diameter or width dimension in a direction orthogonal to the longitudinal axis L in a range of 25 mm to 250 mm, 50 mm to 200 mm, or 75 mm to 150 mm.

As discussed above, the reactor 102 includes first and second lateral ports 112a, 112b including openings formed in the outer wall 104 for receiving the first and second light source assemblies 120a, 120b. However, the present disclosure is not limited this, and may have any number of ports corresponding to the number of light source assemblies. For example, the reactor 102 may include at least one, at least two, or at least three ports 112, and up to twenty, up to ten, or up to five ports 112. The ports 112a, 112b may include an external thread 113a, 113b designed to threadedly engage internal threads 137 (shown in FIG. 4B) of the cap 138 of the light source assembly 120. Alternatively, the ports 112a, 112b may include any other connecting mechanism suitable for detachably connecting to the light source assemblies 120a, 120b.

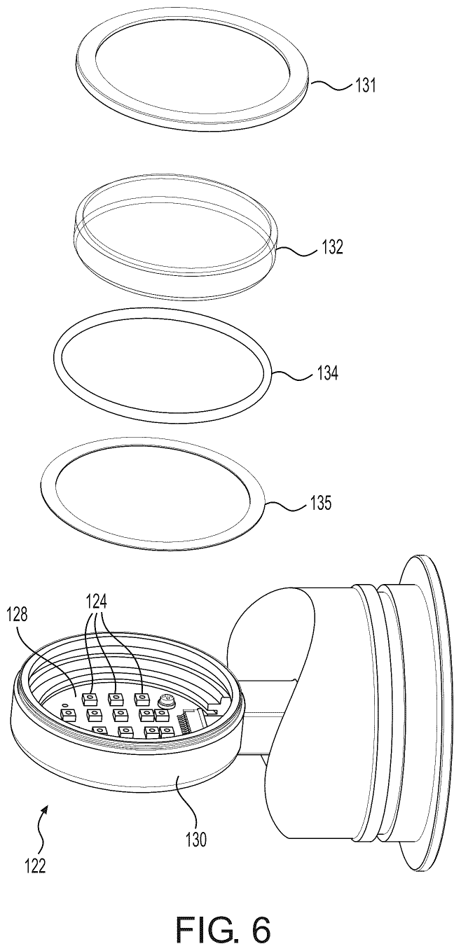

Further details of the light source units 122a, 122b will be discussed with reference to FIGS. 4A-6. FIGS. 4A and 4B show perspective views of an exemplary light source assembly 120, FIG. 5 shows a perspective view of an exemplary light source unit 122 including an array of a plurality of UV LEDs 124, and FIG. 6 shows an exploded view of the light source unit 122. Each light source unit 122 of the assembly 120 may have a disc shape. For example, the light source unit may have a shape resembling a puck. However, the present disclosure is not limited to any particular shape, and each the light source unit 122 may have any suitable shape, including but not limited to cylindrical, conical, frustoconical, cubical, rectangular, or the like. For example, each light source unit 122 may have a circular cross-sectional shape, as shown in FIG. 4A, 4B, and 5. However, the present disclosure is not limited to any particular cross-sectional shape, and the light source unit 122 may have various other cross-sectional shapes, for example, an elliptical shape, a polygonal shape including, for example, a square or rectangular shape, and a semicircular shape. Regardless of shape, the light source units 122a, 122b can be sized relative to the treatment chamber 110 to allow for sufficient fluid flow within the reactor 102 so that the treatment of the fluid is efficient. In this regard, a cross-sectional area of one of the light source units 122a, taken on a plane orthogonal to the longitudinal axis L, can be from 25%-60% of the cross-sectional area of the treatment chamber 110, or from 35%-45% of the cross-sectional area of the treatment chamber 110.

The light source unit 122 may include a thickness dimension that is oriented in the treatment chamber 110 along the longitudinal axis L of the treatment chamber 110 and a width dimension that is oriented in the treatment chamber 110 orthogonally to the longitudinal axis L of the treatment chamber 110. A maximum width dimension of the light source unit 122 may be at least twice that of a maximum thickness dimension of the light source unit 122. The maximum width dimension of the light source unit 122 may be 2 to 20 times larger than the maximum thickness dimension, 3 to 15 times larger than the maximum thickness dimension, or 5 to 10 times larger than the maximum thickness dimension of the light source unit 122. For example, in a case where the light source unit 122 is cylindrical and has a circular cross-sectional shape, the width dimension may correspond to a diameter of the light source unit 122, and the thickness dimension may correspond to a length of the cylindrical light source unit 122 that is oriented in the treatment chamber 110 along the longitudinal axis of the treatment chamber 110 and is orthogonal to the diameter of the light source unit 122.

As mentioned above, each light source unit 122 includes a housing 130 in which the array of UV LEDs 124 is arranged. The housing 130 may be made at least partially of a heat-conductive material, such as stainless steel, aluminum, copper, or alloys thereof, to facilitate heat dissipation from the light source unit 122 to the fluid being treated in the chamber 110. For example, at least a backside of the housing 130, which is opposite to the light-emitting side, may be made of a heat-conductive material to facilitate dissipation of the heat away from the light source unit 122, e.g., into the fluid being treated.

The housing 130 may define the shape of the light source unit 122. For example, the housing 130 may have a disc shape, such as a shape resembling a puck. However, the present disclosure is not limited to any particular shape, and the housing 130 may have any suitable shape, including but not limited to cylindrical, conical, frustoconical, cubical, rectangular, or the like. For example, the housing 130 may have a circular cross-sectional shape, as shown in FIGS. 4A, 4B, and 5. However, the present disclosure is not limited to any particular cross-sectional shape, and the housing 130 may have various other cross-sectional shapes, for example, an elliptical shape, a polygonal shape including, for example, a square or rectangular shape, and a semicircular shape.

The housing 130 may include a thickness dimension that is oriented in the treatment chamber 110 along the longitudinal axis L of the treatment chamber 110 and a width dimension that is oriented in the treatment chamber 110 orthogonally to the longitudinal axis L of the treatment chamber 110. A maximum width dimension of the housing 130 may be at least twice that of a maximum thickness dimension of the housing 130. The maximum width dimension of the housing 130 may be 2 to 20 times larger than the maximum thickness dimension, 3 to 15 times larger than the maximum thickness dimension, or 5 to 10 times larger than the maximum thickness dimension of the housing 30. For example, in a case where the housing 130 is cylindrical and has a circular cross-sectional shape, the width dimension may correspond to a diameter of the housing 130, and the thickness dimension may correspond to a length of the cylindrical housing 130 that is oriented in the treatment chamber 110 along the longitudinal axis L of the treatment chamber 110 and is orthogonal to the diameter of the housing 130.

A UV transparent window 132 may be arranged on the other side (i.e., the light-emitting side) of the housing 130 so as to cover the UV LEDs 124. The UV LEDs 124 are arranged to emit UV radiation through the UV transparent window 132. The window 132 may be made of any material that is suitably transparent to UV radiation, such as quartz or silica glass. The UV transparent window 132 may be machined and have a substantially flat surface. A plane of the UV transparent window 132 may be parallel to the width dimension of the light source unit 122 and the housing 130. The window may be sealed to prevent fluid from entering the lights source unit 122. For example, as shown in FIG. 6, the window 132 may be secured to the housing by a ring 131 or other sealing material. The ring 131 may threadedly engage external threads on the housing 130 to secure the window 132 against the array of UV LEDs 124 arranged in the housing 130. Alternatively, the ring 131 may couple to the housing 130 by any other suitable connection mechanism. One or more O-rings 134, 135 may be used to seal the window 132 against the body of the housing 130 and to secure the opposite side of the window 132 in place over the UV LEDs 124 inside the housing 130. For example, one or more of the O-rings 134, 135 may be made of polytetrafluoroethylene (PTFE). One or both of the O-rings 134, 135 may provide a cushion to protect the window 132 from damage due to pressure in the treatment chamber 110.

The UV LEDs 124 are mounted on and electrically coupled to a circuit board 128, such as a printed circuit board (PCB) or a metal core printed circuit board (MCPCB), which is also arranged in the housing 130 on an opposite side of the window 132. The circuit board 128 may be inset inside the housing 130. A plane of the circuit board 128 may be oriented parallel to the width dimension of the light source unit 122 and the housing 130. The UV LEDs 124 may be arranged in any suitable pattern on the circuit board 128. The number of UV LEDs 124 arranged in the light source unit 122 may be determined based on the flow rate and/or level of disinfection. In one example, the light source unit 122 may include a number of UV LEDs 124 in a range of 5 to 100, a range of 15 to 50, or a range of 10 to 30.

The circuit board 128 may include a metal backing or metal core made of a heat-conductive material, such as copper, aluminum, and alloys thereof, in order to facilitate conducting heat away from the light source unit 122. For example, the heat generated by the light source unit 122 can be dissipated to the fluid being treated into the treatment chamber 110 through the heat-conductive backing or core and the heat-conductive housing 130. The heating-conductive backing on the circuit board 128 may be in direct contact with the thermally-conductive back of the housing 130 to facilitate heat dissipation to the fluid.

The light source unit 122 may be arranged in the treatment chamber 110 such that the UV transparent window 132, the array of LEDs 124, the circuit board 128, and the backside (non-emitting side) of the housing 130 are stacked in this order along a direction of the thickness dimension of the light source unit 122, which extends along the longitudinal axis L of the treatment chamber 110.

The treatment chamber 110 and/or the light source unit 122 may optionally include a UV reflector for facilitating irradiation of the UV light into the fluid flowing through the chamber 110. For example, the UV reflector may be made of any suitably reflective material, such as polytetrafluoroethylene (PTFE), aluminum, stainless steel, or the like. The UV reflector may be provided as a coating applied on an inner surface of the treatment chamber 110, or may be a polished inner surface of the chamber 110, for example, where the chamber wall is made of a reflective material. Alternatively or additionally, a UV reflector may be provided in the light source unit 122, for example, as a parabolic reflector or a reflective coating material, for example, provided on the circuit board 128.

The light source unit 122 may also include one or more sensors, including, for example, a temperature sensor 126, an intensity sensor 127, and/or any other suitable sensor. The sensors may be mounted on the circuit board 128 and electrically coupled thereto, or they may be otherwise provided in or mounted on the light source unit 122 or may include their own circuit board.

The temperature sensor 126 is designed to measure a temperature in the UV light source assembly 120. As shown in FIGS. 4A-5, the temperature sensor 126 may be mounted on the circuit board 128 in the housing 130 and electrically coupled thereto, or the sensor 126 otherwise provided in the light source unit 122. For example, the temperature sensor 126 may be provided in the light source unit 122, for example, inside the housing 130, and may include its own circuit board or other circuitry separate from the circuit board 128 on which the UV LEDs 124 are mounted. As shown in FIGS. 4A-5, the temperature sensor 127 may be mounted on the circuit board 128 and arranged in a center of the light source unit 122, where the light source unit 122 may get hottest during use. The temperature sensor 126 may be a thermistor or a thermocouple any other sensor suitable for sensing a temperature in the light source unit 122.

The system 100 may include one or more temperature sensors 126. For example, the system 100 may include a first temperature sensor located at a relatively upstream position with respect to the flow of the fluid and a second temperature sensor located at a relatively downstream position with respect to the flow of the fluid. With reference to FIG. 2, the first temperature sensor may be arranged in or mounted on the second (relatively upstream) light source assembly 120b, such as in the second light source unit 122b, for measuring a temperature in the second light source assembly 120b, and the second temperature sensor may be arranged in or mounted on the first light source assembly 120a, such as in the first light source unit 122a, for measuring a temperature in the first light source assembly 120a. A temperature sensor 126 may be arranged in each of the light source assemblies 120 or in one or more of the light source assemblies 120 within the system 100.

The temperature sensor 126 may transmit the temperature to the processor 150. For example, the temperature sensor 126 may periodically or intermittently measure the temperature in the light source assembly 120 and transmit the measured temperature to the processor 150. Alternatively or additionally, the temperature sensor 126 may measure the temperature in the light source assembly 120 when instructed by the processor 150, for example, upon the occurrence of a trigger. Methods of controlling the system 100 based on the measured temperature in the light source assembly 120 by the temperature sensor 126 are discussed below.

The light source assembly 120 may additionally or alternatively include a UV light intensity sensor 127 for measuring an intensity of UV light incident thereon. The intensity sensor 127 may be mounted on the circuit board 128 in the light source unit 122 and electrically coupled thereto, or the sensor 127 may be otherwise provided in or on the light source unit 122. For example, the intensity sensor 127 may be provided in the light source unit 122, for example, in the housing 130, and may include its own circuit board or other circuitry separate from the circuit board 128 on which the UV LEDs 124 are mounted. As shown in FIGS. 4A-5, the intensity sensor 127 may be mounted on the circuit board 128 and arranged proximal to the center of the light source unit 122, such as adjacent to the temperature sensor 126. Alternatively, the intensity sensor 127 may be provided at any other suitable location in the light source unit 122 or on the circuit board 128.

The system 100 may include one or more intensity sensors 127. For example, the system 100 may include a first intensity sensor located at a relatively upstream position with respect to the flow of the fluid and a second intensity sensor located at a relatively downstream position with respect to the flow of the fluid. The first intensity sensor may be arranged in or mounted on the first light source assembly 120a, such as in the first light source unit 122a, and the second intensity sensor may be arranged in or mounted on the second light source assembly 120b, such as in the second light source unit 122b. An intensity sensor 127 may be arranged in each of the light source assemblies 120 or in one or more of the light source assemblies 120 within the system 100.

By arranging an intensity sensor 126 in or on at least one of the light source units 122a, 122b, there may be no need to provide a separate sensor module including housing, a dedicated window, seals, and electrical components for the sensor 127, which can increase cost and reliability issues. Instead, the sensor 127 can be sealed in the light source unit 122 and electrically coupled to the same circuit board 128 as the UV LEDs 124.

The intensity sensor 127 may be designed to measure an intensity of UV light incident thereon. For example, the intensity sensor 127 may measure an intensity of UV light emitted by an opposing light source unit or it may measure an intensity of UV light emitted by the light source unit in which it is arranged (the self source unit) through lateral emission or back reflected light from the window 132. The intensity sensor 127 may be, for example, an intensity sensor chip, photodiode, photodetector, photoresistor, a UV phototube, or any other suitable sensor for measuring the intensity of UV light.

The intensity sensor 127 may transmit the measured intensity to the processor 150. For example, the intensity sensor 127 may periodically or intermittently measure the intensity of UV light incident thereon and transmit the measured intensity to the processor 150. Alternatively or additionally, the intensity sensor 127 may measure the intensity of UV light incident thereon when instructed by the processor 150, for example, upon the occurrence of a trigger.

The intensity measurements may be used to evaluate and monitor the health of the light source unit 122. LEDs degrade over time, and monitoring the intensity of light emitted by the LEDs 124 can help evaluate how the LEDs are aging. Additionally, the UV sensor 127 may be used to monitoring fouling of the light source unit 122 to determine whether the light source unit 122 should be cleaned. As discussed above, during use, the light source unit 122 periodically becomes fouled with foreign materials, which can inhibit its ability to transmit UV radiation to the fluid, resulting in a decrease in intensity. Thus, the intensity sensor 127 may be used to determine whether the light source unit 122 should be removed for cleaning or other servicing. When the intensity of UV light detected by the sensor 127 is decreased, the system may output a notification, for example, in the form of a sound, light, or other error message, indicating that the light source unit 122 may need or benefit from servicing or cleaning.

For example, referring to FIG. 2, to determine the health or condition of the light source units 122a, 122b, the intensity sensor 127 in the first light source unit 122a may measure an intensity of light emitted by the second light source unit 122b while the first light source unit 122a is temporarily turned off to evaluate the health of the second light source unit 122b or to determine whether the second light source unit 122b should be or may benefit from being cleaned or serviced. The second light source unit 122b then may be temporarily turned off, and the intensity sensor 127 in the second light source unit 122b may measure an intensity of light emitted by the first light source unit 122a to evaluate the health of the first light source unit 122a and/or determine whether the first light source unit 122a should be or may benefit from being cleaned or serviced. The intensity sensor 127 may additionally be able to monitor the health and fouling condition of the light source unit 122 in which the sensor 127 is arranged (the self source unit) by temporarily turning off the other light source unit and measuring the intensity light of the self source unit 122 through lateral emission from the LEDs 124 or back reflected light from the window 132 of the self source unit 122.

The present disclosure is not limited the arrangement of the intensity sensor 127 shown in FIGS. 4A-5 or as discussed above. The intensity sensor 127 may be arranged in any suitable location within the reactor 102, e.g., in the treatment chamber 110, for measuring an intensity of UV light incident thereon. For instance, instead of being arranged in or on the light source assembly 120, the intensity sensor 127 may be arranged in the treatment chamber 110 outside of the light source assembly 120. For example, the intensity sensor 127 may be arranged in an intensity sensor module (not shown) that is suspended in the treatment chamber 110 through its own port in a similar manner to the light source assemblies 120a, 120b, as shown in FIGS. 1 and 2. Alternatively, the intensity sensor 127 may be arranged in an intensity sensor module on a wall 104 of the reactor 102, or any other suitable location for measuring an intensity of UV light.

The light source assembly 120, the reactor 102, and/or the system 100 may include any other suitable sensor in place of or in addition to the temperature sensor 126, the intensity sensor 127, the flow rate sensor 114, and/or the fluid temperature sensor.

The circuit board 128 may further include a connector 142, such as a multi-pin connector for electrically connecting the circuit board 128 to a power source. For example, the connector may be connected to one end of a ribbon cable 140 (shown in FIG. 4B). As discussed in more detail below, the ribbon cable 140 extends outside of the light source unit 122. For example, the other end of the ribbon cable 140 may be connected to a circuit board 148 arranged in the cap 138.

As mentioned above, the light source assembly 120 also includes a cap 138 for coupling the assembly to the reactor 102. The light source unit 122 is mounted on a mounting arm 146 that extends from the cap 138. The ribbon cable 140 may be arranged to extend from the connector 142 through an inner channel of the mounting arm 146 to inside of the cap 138, where it is coupled to a connector 144 provided on the circuit board 148. The circuit board 148 inside the cap 138 may be coupled to a power source. For example, referring to FIG. 1, the circuit board 128 in each of the light source assemblies 120a, 120b is electrically coupled to a power source via cables 121a, 121b.

The cap 138 further includes internal threads 137 for coupling to a lateral port 112 of the reactor 102. For example, the internal threads 137 of the cap 138 may be designed to threadedly engage external threads 113 provided on the lateral port 112 of the reactor 102. However, the present disclosure is not limited to a threaded connection, and any other suitable connection mechanism may be used.

Although embodiments disclosed herein have been described with respect to treating water and/or aqueous fluids with UV radiation treatment, the present disclosure is not limited to water and aqueous fluids, and may be used to treat any fluid, including liquids, vapors, gels, plasmas, and gases. Similarly, the present disclosure is not limited to residential UV treatment systems, and may be applied to industrial, municipal, and commercial systems.

### Methods of Operating a Fluid Treatment System

Disclosed herein are methods of operating a system 100, such as but not limited to any of the above described systems, for treating a fluid that flows through the reactor 102 and is exposed to UV light emitted from the UV light source assembly 120.

### UV Power Control at Low or No Flow

One method includes detecting, with the flow sensor 114, a flow rate of the fluid flowing through the reactor 102, and controlling, with at least one processor 150, electric power supplied to the UV light source assembly 120. For example, the processor 150 may control the flow sensor 114 to measure the flow rate of fluid flowing through the treatment chamber 110 and the flow sensor 114 may transmit the measured flow rate to the processor 150. The flow sensor 114 may continuously, periodically, or intermittently measure the flow rate and/or the flow sensor 114 may measure the flow rate upon instruction from the processor 150, for example, due to the occurrence of a trigger.

The processor 150 may use the flow rate to control the electric power supplied to the UV light source assembly 120 for emitting UV light to treat the fluid. In particular, the processor 150 may control the electric power supplied to the UV light source assembly 120 so that: (i) an amount of the electric power is adjusted based on the detected flow rate in a first state in which the detected flow rate is greater than or equal to a threshold flow rate, and (ii) a low average amount of electric power is supplied to the UV light source assembly in a second state in which the detected flow rate is below the threshold flow rate. The processor 150 may be configured continuously, periodically, or intermittently compare the detected flow rate by the flow sensor 114 to the threshold flow rate to determine whether to switch to the first state or the second state.

The threshold flow rate may be a lowest detectable flow rate (e.g., a detection threshold) of the flow sensor 114 or may be any other flow rate indicative of low or no fluid flow through the treatment chamber 110. Low or no flow through the treatment chamber 110 may mean, for example, that the fluid in the treatment chamber 110 is substantially stagnant and may be in a steady state, as discussed in more detail below. In the substantially stagnant state and/or the steady state, the fluid may have a flow rate of less than 2 gallons per minute (gpm), 1 gpm or less, 0.5 gpm or less, or 0.25 gpm or less, including a flow rate of 0 gpm. As such, for example, the threshold flow rate may be about 2 gpm, about 1 gpm, about 0.5 gpm, or about 0.25 gpm, or any other suitable value indicative of a substantially stagnant state and/or below which lower UV power may be used.

The first state, in which the detected flow rate is greater than or equal to the threshold flow rate, may be the bulk of the flow rate range. For example, in the first state, the flow rate may be in a range of 2 to 25 gpm, 5 to 20 gpm, or 10 to 15 gpm, or any other suitable range depending on, for example, the particular system in which the reactor 102 is arranged. In the first state, the processor 150 may modulate the electric power supplied to the light source assembly 120 or light source assemblies if there is more than one based on the detected flow rate. For example, the processor 150 may adjust the amount of electric power supplied to the light source assembly 120 proportionally to the detected flow rate by the flow sensor 114. If the detected flow rate increases, the processor 150 may increase the electric power supplied to the light source assembly 120 proportionally, and if the detected flow rate decreases, the processor 150 may decrease the electric power supplied to the light source assembly 120 proportionally. The electric power supplied to the light source assembly 120 may be adjusted in a stepwise or continuous manner proportionally to the detected flow rate or the electric power may be adjusted in any other suitable manner based on the detected flow rate.

In the second state, the detected flow rate is less than the threshold flow rate, which indicates that the fluid in the reactor 102 is substantially stagnant. Instead of turning off power to the light source assembly 120 in the second state, the inventors found that efficiency and disinfection can be improved by treating the substantially stagnant fluid with a lower amount of UV light radiation to avoid potential diffusion of biological contaminants downstream of the reactor 102. Therefore, in the second state, the light source assembly 120 may be operated in a low flow or idle mode in which a low average amount of electric power is supplied to the light source assembly 120. This may conserve power while continuing to ensure adequate disinfection in the second state in which the fluid is substantially stagnant, and thereby improve efficiency of the system 100 and extend the lifetime of the UV LEDs 124.

In particular, when the processor 150 receives a detected flow rate from the flow sensor 114 that is below the threshold flow rate, the processor 150 may be configured to reduce power to the light source assembly 120, for example, to the UV LED array 124. For example, the processor 150 may switch to a low flow or idle mode in which a low average amount of electric power is supplied to the light source assembly 120. The low average amount of electric power has a non-zero value and is lower than the amount of electric power supplied to the light source assembly 120 in the first state over a given time. For example, to prevent possible diffusion of pathogens or other contaminants downstream of the reactor 102 in the second state, the processor 150 may control the electric power so that the low average amount of electric power supplied to the light source assembly 120 is at least 5%, at least 10%, or at least 15% of a maximum amount of electric power than can be supplied to the UV light source assembly 120. The low average amount of electric power supplied to the light source assembly 120 in the second state may be in a range of 5 to 30%, 10 to 25%, or 15 to 20% of a maximum amount of electric power than can be supplied to the UV light source assembly 120.

Unlike the first state, the low average amount of power supplied to the light source assembly 120 in the second state is not based on or adjusted based on the detected flow rate. The amount of power supplied to the light source assembly 120 at any given time in the second state may also not be based on or adjusted based on the detected flow rate. For example, neither the average amount of power nor the amount of power supplied to the light source assembly 120 in the second state is proportional to the detected flow rate. Nor is the amount of electric power supplied to the light source assembly 120 in the second state adjusted, in a proportional or other manner, based on changes in the flow rate in the second state. Instead, when the processor 150 determines that the detected flow rate is below the threshold flow rate, the processor 150 may determine that the system is in the second state, in which the fluid is substantially stagnant, and the processor 150 may switch to a low flow or idle mode in which a low average amount of electric power is supplied to the light source assembly 120 in the second state. The processor 150 may continue to supply the low average amount of electric power to the light source assembly 120 in the second state until or if the processor 150 determines that the detected flow rate is greater than or equal to the threshold flow rate. Upon determining that the flow rate is greater than or equal to the threshold flow rate, the processor 150 may determine that the system is in the first state, and may then switch to modulating the electric power based on the detected flow.

In an embodiment, the processor 150 may control the electric power through pulse width modulation (PWM) in the second state. Controlling the electric power supplied to the light source assembly 120 through PWM in the second state may be advantageous, especially if the LEDs 124 do not tolerate lower currents. For example, upon determining that the detected flow rate is less than the threshold flow rate, the processor 150 may switch to a low flow or idle mode in which the electric power supplied to the light source assembly 120 is controlled through PWM in the second state. For example, the electric power supplied to the light source assembly 120 may be pulsed at full power so that the average amount of the electric power supplied to the light source assembly 120 over time in the second state is lower than the amount of electric power supplied to the light source assembly in the first state over a given time. The PWM frequency may be selected so that the average amount of electric power supplied to the light source assembly 120 in the second state is lower than the amount of electric power supplied at any given time in the first state and/or lower than the average amount of electric power supplied in the first state over a given time. The PWM frequency may be controlled so that the average amount of electric power supplied to the light source assembly 120 in the second state is at least 5%, at least 10%, or at least 15% of the maximum amount of electric power that can be supplied to the light source assembly 120. For example, the PWM frequency may be determined so that an adequate amount of UV radiation may be emitted by the light source assembly 120 for treating and inactivating pathogens and other contaminants in the substantially stagnant fluid in the treatment chamber 110, e.g., so as to avoid diffusion of pathogens or other contaminants downstream of the reactor 102 in the flow path.

By this method, power to the LEDs 124 in the light source assembly 120 may be conserved during periods of low or no flow (e.g., when the fluid is substantially stagnant). This may extend the lifetime of the LEDs 124 and/or light source assembly 120 while reducing the risk of pathogens or other contaminants from reproducing and/or diffusing along the flow path and into the downstream water supply even in the substantially stagnant state.

### Determining Whether the Flow Sensor is Defective

Another method of operating a system 100 for treating a fluid that flows through the reactor 102 and is exposed to UV light emitted from the UV light source assembly 120 includes detecting, with at least one temperature sensor 126, a temperature in the UV light source assembly 120; detecting, with the flow sensor 114, a flow rate of the fluid through the reactor 102; and determining, by at least one processor 150, that the flow sensor 114 is defective based on the detected temperature and the detected flow rate.

As discussed above, the flow sensor 114 may periodically, continuously, or intermittently detect a flow rate of fluid flowing through the reactor 102, and/or the flow sensor 114 may detect the flow rate when instructed by the processor 150, for example, upon the occurrence of a trigger. The flow sensor 114 may transmit the measured flow rate to the processor 150. As discussed above, the flow rate may be used to control the electric power supplied to the UV light source assembly 120 for emitting UV light to treat the fluid. However, if the flow sensor 114 is defective (e.g., malfunctions), then the processor 150 may erroneously enter the second state, e.g., the low flow or idle mode, in which a low average amount of electric power is supplied to the light source assembly 120. In that case, there is a risk that the amount of UV light transmitted to the fluid flowing through the reactor 102 could be insufficient to adequately treat the fluid and eliminate and/or reduce contaminants and/or pathogens in the fluid. As a result, there is a risk that contaminated fluid could reach the consumer. The present method may prevent or reduce the likelihood of such an occurrence.

As discussed above, the temperature sensor 126 may continuously, periodically, or intermittently detect a temperature in the UV light source assembly 120, and/or the temperature sensor 126 may detect a temperature in the UV light source assembly 120 when instructed by the processor 150, for example, upon the occurrence of a trigger. The temperature sensor 126 may transmit the measured temperature to the processor 150.

The processor 150 may use the measured temperature in the light source assembly 120 to determine whether the flow sensor 114 is defective. When there is no flow or low flow through the treatment chamber 110 of the reactor 102, the fluid may be in a substantially stagnant state. The substantially stagnant state may be a state in which the flow rate of the fluid through the reactor 102 is below a detection limit of the flow sensor 114. For example, as discussed above, in the substantially stagnant state, the fluid may have a flow rate of less than 2 gallons per minute (gpm), 1 gpm or less, 0.5 gpm or less, or 0.25 gpm or less, including a flow rate of 0 gpm. When the fluid in the treatment chamber 110 is in the substantially stagnant state, the temperature of the light source assembly 120 may increase due to heat being generated from the UV LED array 124 and other electrical components in the light source assembly 120 even when the processor 150 controls the electric power supplied to the light source assembly 120 according to the second state (in which a low average amount of electric power is supplied to the light source assembly 120). Heat from the light source assembly 120, e.g., heat generated by the LEDs 124, may be transferred to the fluid, thereby increasing the temperature of the fluid. Because the fluid is substantially stagnant, cooler fluid flowing from an upstream fluid source will not contact or impinge on the light source assembly 120 to cool the light source assembly 120, as discussed above. In the absence of this cooling effect by the flowing fluid, the temperature of the light source assembly 120 may increase in a state in which the fluid is substantially stagnant.

The increase in temperature may occur gradually over time during the substantially stagnant fluid state. For example, upon entering the substantially stagnant fluid state, the temperature of the light source assembly 120 may initially decrease slightly or may stay substantially the same as heat from the light source assembly 120 is transferred to the fluid. However, as the temperature of the fluid increases due to the transfer of heat from the light source assembly 120, and as the light source assembly 120, e.g., the LED arrays 124, continue to generate heat (even when powered according to the second state), the temperature of the light source assembly 120 may increase over time. For example, the temperature of the light source assembly may increase over time by an amount in a range of from 0.5° C. to 10° C., 1° C. to 5° C., or 2° to 3° C. when the fluid flow through the reactor 102 is substantially stagnant. This temperature increase may occur gradually after the system 100 has been in the substantially stagnant state for a period of time, such as a period of time in a range of at least 30 minutes, at least 1 hour, at least 2 hours, or at least 3 or 4 hours, and up to or beyond, for example, 24 hours, 10 hours, or 5 hours. After this period of time, the system 100 may reach a steady state in which the temperature of the light source assembly 120 may stay substantially the same absent a change in, for example, fluid flow, an amount of power supplied to the light source assembly 120, or the like. For example, during the steady state, the light source assembly 120 and the fluid may reach an equilibrium temperature such that the temperature in the light source assembly 120 stays substantially the same and/or does not significantly change.

Upon flow of fluid through the treatment chamber 110 of the reactor 102, for example, after being in the substantially stagnant state and/or the steady state, the light source assembly 120 may be cooled by the fluid flowing through the treatment chamber 110, which will contact and impinge on the light source assembly 120. Therefore, the temperature in the light source assembly 120 may decrease upon fluid flow through the treatment chamber 110. Alternatively, if the temperature of the fluid upstream of the inlet 106 is higher than the temperature of the light source assembly 120, then the temperature of the light source assembly 120 may increase upon flow of fluid through the treatment chamber 110. For example, when the fluid changes from the substantially stagnant state and/or the steady state to a state in which the fluid flows through the reactor 102, e.g., at a flow rate greater than or equal to the threshold flow rate, the temperature in the light source assembly 120 may change by an amount in a range of from 1° C. to 10° C., 2° C. to 5° C., or 3° to 4° C. The change in temperature in the light source assembly 120 upon fluid flow, for example, after being in the steady state may be greater than the change in temperature during the substantially stagnant state and/or the steady state. The change in temperature upon fluid flow through the treatment chamber 110 may also be more rapid (i.e., have a higher rate of change) than the change in temperature during the substantially stagnant state and/or the steady state. The change in temperature upon flow of fluid through the treatment chamber 110 may also be more rapid than other gradual changes in temperature due to, for example, changes in ambient temperature, temperature of the fluid, temperature of the reactor 102, and the like.

Therefore, the temperature of the light source assembly 120, the change in temperature of the light source assembly 120, and/or the rate of change in the temperature in the light source assembly can be used to determine whether there is fluid flow through the reactor 102 and/or whether the flow sensor 114 is defective. Upon receiving the detected temperature from the temperature sensor 126, the processor 150 may be configured to determine a temperature parameter based on the temperature measured by the sensor 126. The temperature parameter may be at least one of a change in the temperature detected by the temperature sensor 126, a rate of change in the detected temperature by the sensor 126, and an absolute temperature value. The absolute temperature value may be, for example, a temperature value on the Kelvin or Rankine temperature scales.

The processor 150 may use the temperature measured by the temperature sensor 126 and/or the temperature parameter to determine whether there is fluid flow through the reactor 102 and/or whether the flow sensor 114 is defective. The processor 150 may compare the temperature measured by the temperature sensor 126 or the temperature parameter determined by the processor 150 to the flow rate measured by the flow sensor 114 to determine whether the flow sensor 114 is defective. For example, the processor 150 may determine that the flow sensor 114 is defective if the temperature detected by the sensor 126 or the temperature parameter determined by the processor 150 is outside of a predetermined range and the flow rate detected by the flow sensor is below a threshold flow rate.

The threshold flow rate may be the same as or different from the threshold flow rate described above with respect to the methods of controlling electric power supply to the light source assembly. For example, the threshold flow rate may be a lowest detectable flow rate (detection threshold) of the flow sensor 114 or may be any other flow rate indicative of the substantially stagnant or steady state. As mentioned above, the fluid in the treatment chamber 110 may have a flow rate of less than 2 gallons per minute (gpm), 1 gpm or less, 0.5 gpm or less, or 0.25 gpm or less, including a flow rate of 0 gpm, in the substantially stagnant and/or steady states. As such, for example, the threshold flow rate may be about 2 gpm, about 1 gpm, about 0.5 gpm, or about 0.25 gpm. If the flow rate detected by the flow sensor 114 is below the threshold flow rate, then this may indicate that the fluid is substantially stagnant.

The predetermined range, with which the detected temperature and/or temperature parameter is compared, may be a range of temperatures in the light source assembly 120 or corresponding absolute temperature values indicative of the substantially stagnant state and/or the steady state. Thus, when the temperature detected by the sensor 126 or absolute temperature value determined by the processor 150 is within the predetermined temperature range, this may indicate that the fluid in the treatment chamber 110 is substantially stagnant. On the other hand, when the temperature detected by the sensor 126 or the corresponding absolute temperature value is outside of the predetermined temperature range, this may indicate that fluid is flowing through the treatment chamber 110, for example, at a flow rate greater than or equal to the threshold flow rate.

If the temperature of the upstream fluid is generally cooler than the light source assembly 120, then the detected temperature and/or absolute temperature value may be compared to a threshold value. The threshold value may, for example, correspond to the equilibrium temperature reached in the steady state, and/or or may correspond to a temperature in the light source assembly 120 during the substantially stagnant state before reaching the steady state. If the detected temperature is below the threshold value, then this may indicate a change from the substantially stagnant and/or steady state to the fluid flow state.

The predetermined range may alternatively or additionally be a range of changes in temperature in the light source assembly 120 that are indicative of the substantially stagnant and/or steady state. For example, the predetermined range may be a range of changes in temperature that are not indicative of a change from the substantially stagnant and/or steady state to a fluid flow state in which, for example, the flow is rate is greater than or equal to the threshold flow rate. For example, the predetermined range may correspond to a range of changes in the temperature of the light source assembly 120 during the substantially stagnant state or the steady state due to, for example, changes in reactor 102 temperature, changes in ambient temperature, and the like. The predetermined range of changes in temperature may be lower than the change in temperature upon fluid flow through the reactor 102. If the change in temperature detected by the temperature sensor 126 exceeds or is otherwise outside of the predetermined range of temperature changes, then this may indicate a change from the substantially stagnant state and/or the steady state to fluid flow through the reactor 102.

Alternatively, the change in detected temperature may be compared to a threshold value to determine whether the change in detected temperature may be indicative of fluid flow. For example, the threshold value may be based on a value of a maximum temperature change during the substantially stagnant and/or steady states such that a temperature change exceeding this value may be indicative of a change from the substantially stagnant state or the steady state to a fluid flow state in which, for example, the flow rate is greater than or equal to the threshold flow rate. For example, the threshold value may be just above the maximum temperature change during the substantially stagnant and/or steady states and/or just below the temperature change indicative of a change from the substantially stagnant and/or steady state to the fluid flow state.

Similarly, the predetermined range may alternatively or additionally be a range of rates of temperature changes in the light source assembly 120 that are not indicative of a change in fluid flow. For example, the predetermined range may correspond to a range of rates of changes in temperature in the light source assembly 120 consistent with the substantially stagnant state and/or the steady state, in which changes in temperature may be more gradual. Therefore, if the rate of change in temperature detected by the temperature sensor 126 exceeds or is otherwise outside of the predetermined range of rates of temperature changes, then this may be indicate a change from a substantially stagnant state or the steady state to a state of fluid flow through the reactor 102.

Alternatively, the rate of change in detected temperature may be compared to a threshold value to determine whether the rate of change in detected temperature may be indicative of fluid flow. For example, the threshold value may be based on a maximum rate of temperature change during the substantially stagnant state or the steady state such that a rate of change exceeding this value may be indicative of a change from the substantially stagnant state and/or the steady state to the fluid flow state, in which, for example, the flow rate is greater than or equal to the threshold flow rate. For example, the threshold value may be just above the maximum rate of temperature change during the substantially stagnant and/or steady states and/or just below a rate of temperature change indicative of a change from the substantially stagnant and/or steady state to the fluid flow state.

The predetermined range of temperatures, absolute temperature values, changes in temperature, and rates of change, and the threshold values for the same may be determined based on the particular system, including, for example, the size of the reactor 102, volume of fluid, and number of light source assemblies 120. For example, after the system has been at a substantially stagnant and/or steady state for a period of time in a range of 60 minutes to 500 minutes, a range of 90 minutes to 250 minutes, or a range of 150 minutes to 210 minutes, then the detected temperature, absolute temperature, change in temperature, rate of change in temperature, or other temperature parameter may be compared to a corresponding predetermined range or threshold value. For example, the threshold change in temperature and threshold rate of change after the system has been at the substantially stagnant and/or steady state may be a change in temperature (e.g., an increase or decrease in temperature) of at least 0.5° C., at least 1° C., or at least 2° C. within a period of time in a range of 1 to 30 seconds, 5 to 20 seconds, or 10 to 15 seconds. By way of example, if the system has been in the substantially stagnant and/or steady state for at least 180 minutes, and the processor detects a decrease in temperature by 2° C. within a 10 second period, then the processor may determine that there is fluid flow through the reactor 102.

At least one of, at least two of, or at least three of: the temperature detected by the temperature sensor 126 and the temperature parameters determined by the processor 150 may be individually compared to a respective predetermined range or threshold value. The processor 150 may determine that there is fluid flow through the reactor 102 if at least one, at least two, at least three, or all of the detected temperature and the temperature parameters are outside of the respective predetermined ranges and/or exceed the respective threshold values. For example, the processor 150 may compare both the amount of change in the detected temperature and the rate of change in the detected temperature to a respective predetermined range or respective threshold value. If both the amount of change and the rate of change exceed or are outside of the predetermined range or threshold value, then this may indicate fluid flow through the reactor 102.

The processor 150 may further be configured to determine whether the fluid is in the steady state before determining whether there is a change in fluid flow through the reactor 102 and/or whether the flow sensor 114 is defective. For example, the processor 150 may determine that the fluid is in the steady state based on the flow rate detected by the flow sensor 114 and/or the detected temperature or temperature parameter. For example, if the detected temperature and/or one or more of the temperature parameters stay substantially the same for a given period of time, then the processor 150 may determine that the system is in the steady state. For example, if the detected temperature, the absolute temperature value, the change in temperature, and/or the rate of change in temperature stay substantially the same for a period in a range of 0.5 to 10 hours, 1 to 5 hours, or 2 to 4 hours, then the processor 150 may determine that the system is in the steady state. This may mean, for example, that the detected temperature and/or one or more of the temperature parameters do not change by more than a small or nominal amount for the period of time. The processor 150 may further determine that the system 100 is in the steady state if the detected temperature and/or temperature parameter stabilize so as to only change by a small or nominal amount for the period of time after determining that the detected temperature and/or temperature parameter changed by an amount indicative of the substantially stagnant state, for example, if the detected temperature increased by an amount and/or at a rate of change indicative of the substantially stagnant state, as discussed above.

Alternatively or additionally, the processor 150 may compare the detected temperature and/or at least one of the temperature parameters to a predetermined range or a threshold value indicative of the steady state. As discussed above, the detected temperature in the steady state may be higher than a state in which there is fluid flow through the reactor 102. Alternatively, if the upstream fluid source has a higher temperature than the temperature in the light source assembly 120, then the detected temperature may be lower in the steady state than when there is fluid flow. Therefore, if the detected temperature and/or at least one temperature parameter is outside of a predetermined range for the period of time, then the processor 150 may determine that the system 100 is in the steady state. The predetermined range may be a range of temperatures or absolute temperature values, a range of temperature changes, and/or a range of rates of temperature changes that are indicative of fluid flow through the reactor.

Alternatively, the change in temperature and/or the rate of change in temperature may be compared to a threshold value. If the change in temperature and/or the rate of change is less than the threshold value over the period of time, then the processor may determine that the system 100 is in the steady state. The threshold value may be a change in temperature or a rate of change in temperature that is indicative of fluid flow. If the upstream fluid is generally cooler than the light source assembly 120, then the detected temperature and/or absolute temperature value may similarly be compared to a threshold value indicative of the fluid flow state to determine whether the system 100 is in the steady state. For instance, if the detected temperature and/or absolute temperature value exceeds the threshold value over the period of time, then the processor 150 may determine that the system 100 is in the steady state.

After the processor 150 determines that the system 100 is in the steady state, the processor 150 may continue to monitor the temperature detected by the temperature sensor 126 and/or determine and monitor one or more of the temperature parameters to determine whether the system 100 has changed from the steady state, in which the fluid flow through the reactor 102 is substantially stagnant, to a state in which the fluid is flowing through the reactor 102 and/or whether the flow sensor 114 is defective.

If the temperature detected by the sensor 126 and/or the temperature parameter determined by the processor 150 is outside of the predetermined range or exceeds the threshold value, which is indicative of fluid flow through the reactor 102, and the flow rate detected by the flow sensor 114 is below the threshold flow rate, which indicates that the fluid in the reactor 102 is substantially stagnant, then the processor 150 may determine that the flow sensor 114 is defective.

When the processor 150 determines that the flow sensor 114 is defective, the processor 150 may send a notification signal, such as a visual indicator, test, a sound, or any other suitable notification signal. The flow sensor 114 may subsequently be serviced and fixed or replaced. When the processor 150 determines that the flow sensor 114 is defective, and if power to the UV light source assembly is off, then the processor may further turn on power to the UV light source assembly 120 to expose the fluid to the UV light, e.g., to prevent contaminated fluid from flowing downstream of the reactor 102. If the processor 150 determines that the flow sensor 114 is defective, the processor 150 may otherwise increase the power to the UV light source assembly 120 to a maximum power so as to emit a maximum intensity and/or amount of UV light, e.g., to ensure that the fluid is adequately treated with UV light.

After the processor 150 determines that the flow sensor 114 is defective, the processor 150 may control the intensity of UV light based on the detected temperature by the temperature sensor 126 instead shutting down the system 100. The processor 150 may control the intensity of UV light based on the detected temperature according to the method discussed below. Such control of the intensity of UV light based on the detected temperature by the sensor 126 may be temporary, for example, until the flow sensor 114 can be fixed or replaced. Alternatively, as discussed below, the processor 150 may control the intensity of UV light based on the detected temperature as a primary control mechanism.

The foregoing and below methods enable the temperature sensor 126 to be used as a failsafe to detect whether the flow sensor 114 is working or defective and/or whether there is fluid flow through the reactor 102. For example, the temperature sensor 126 may operate as a secondary sensor for determining fluid flow through the reactor 102 that operates on a different principle than the flow sensor 114. This may prevent a situation in which the processor 150 changes to the second state in which a low average amount of electric power is supplied to the UV light source 120 so as to reduce the amount of UV radiation transmitted to the fluid (e.g., reduce the intensity of UV light and/or the average intensity of UV light over time) based on an erroneous signal transmitted from a defective flow sensor 114 indicating that the flow rate of the fluid through the reactor is below the threshold flow rate. Thus, by using the temperature sensor 126 as a secondary sensor for detecting fluid flow, a situation in which potentially contaminated fluid reaches the consumer may be avoided.

### Controlling an Intensity of UV Light Based on the Detected Temperature

Another method of operating a system 100 for treating a fluid that flows through a reactor 102 and is exposed to UV light emitted from the UV light source assembly 120 includes detecting, with at least one temperature sensor 126, a temperature in the UV light source assembly 120, and controlling, with at least one processor 150, an intensity of the UV light based on the detected temperature from the at least one temperature sensor 126.

In this method, the temperature sensor 126 may be used as a secondary or back up sensor for controlling the intensity of UV light, e.g., if the flow sensor 114 fails or is otherwise defective, or the temperature sensor 126 may be used as the primary sensor for controlling the intensity of UV light (e.g., regardless of the state, health, or presence of the flow sensor 114).

As discussed above, the processor 150 may further determine a temperature parameter from the temperature detected by the temperature sensor 126. The temperature parameter may be at least one of a change in the temperature detected by the temperature sensor 126, a rate of change in the detected temperature by the sensor 126, and an absolute temperature value.

The processor 150 may control the intensity of UV light emitted by the UV light source assembly 120 based on the temperature measured by the temperature sensor 126 or the temperature parameter determined by the processor 150. For example, the processor 150 may control the intensity of the UV light by controlling the electrical power supplied to one or more of the UV light source assemblies 120a, 120b, for example, via cables 121a, 121b. The processor 150 may determine the flow rate of the fluid based on the detected temperature in the light source assembly 120 by the temperature sensor 126 or the temperature parameter determined by the processor 150.

A temperature of the fluid flowing through the treatment chamber 110 may further be detected by a fluid temperature sensor (not shown) arranged in the reactor 102, e.g., in the treatment chamber 110, in the inlet 106, and/or in the outlet 108. The processor 150 may further control the intensity of UV light based on the detected fluid temperature. The processor 150 may determine a flow rate of the fluid flowing through the treatment chamber 110 of the reactor 102 based on the temperature in the light source assembly 120 measured by the temperature sensor 126, and a temperature of the fluid measured by the fluid temperature sensor.

As discussed above, the system 100 may include one or more temperature sensors 126 including a first temperature sensor located at a relatively upstream position with respect to the flow of the fluid and a second temperature sensor located at a relatively downstream position with respect to the flow of the fluid. For example, with reference to FIG. 2, the first temperature sensor may be arranged in or mounted on the second (relatively upstream) light source assembly 120b, such as in the second light source unit 122b, and the second temperature sensor may be arranged in or mounted on the first (relatively downstream) light source assembly 120a, such as in the first light source unit 122a. By using at least two temperature sensors 126, then the health or condition of the temperature sensors can also be determined. For example, the temperature sensors 126 may continuously, periodically, intermittently, or otherwise detect the temperature in the respective light source assembly 120 in which they are arranged. The temperature sensors 126 may transmit the detected temperatures to the processor 150. The processor 150 may compare the temperatures detected by the respective temperature sensors 126 and determine whether one or more of the temperature sensors 126 are defective based on the comparison.

For example, in the case where a first temperature sensor is located at a relatively upstream position with respect to the flow of the fluid and a second temperature sensor is located at a relatively downstream position with respect to the flow of the fluid, the upstream light source assembly may cool better than the downstream light source assembly. As such, the temperature detected by the first temperature sensor may be lower than the temperature detected by the second temperature sensor. This may be because when the fluid cools the upstream light source assembly, heat from the upstream light source assembly is transferred to the fluid. Therefore, the fluid impinging on and cooling the downstream light source assembly may have a higher temperature than the fluid impinging on and cooling the upstream light source assembly. As such the downstream light source assembly may not be cooled as much as the upstream light source assembly. With reference to FIG. 2, this may means that the second (relatively upstream) light source assembly 120b may be cooler (i.e., have a lower temperature) than the first (relatively downstream) light source assembly 120a in the fluid flow state.

The processor 150 may take this expected difference in temperature between an upstream and a downstream light source assembly, especially when there is fluid flow, into account when comparing the temperatures detected by the first and second temperature sensors. For example, the processor 150 may determine that one of the first and second temperature sensors are defective if a difference between the temperatures detected by the first and second temperature sensors is greater than a predetermined value. The predetermined value may be set based on the expected difference in temperature between the upstream and the downstream light source assemblies. For example, the predetermined value may be a value in a range of from 0.5° C. to 10° C., 1° C. to 5° C., or 2° C. to 3° C., or the predetermined value may be any suitable value.

As discussed above, the processor 150 may determine a temperature parameter, such as one or more of a change in the detected temperature, a rate of change in the detected temperature, and an absolute temperature value. The processor 150 may determine a first temperature parameter based on the temperature detected by the first temperature sensor and a second temperature parameter based on the temperature detected by the second temperature sensor. The processor 150 may compare the first temperature parameter based on the temperature detected by the first temperature sensor with the second temperature parameter based on the temperature detected by the second temperature sensor, and determine that one of the first and second temperature sensors is defective based on the comparison. For example, as discussed above, upon fluid flow through the reactor 102, the temperature of the light source assemblies 120a, 120b may change. The change in temperature in the light source assemblies 120a, 120b may be more rapid than other gradual changes in temperature. Thus, in addition to the actual and absolute temperature values detected by the first and second temperature sensors, the change in temperature and/or the rate of change in temperature detected by each of the first and second temperature sensors upon fluid flow may be compared to determine whether one of the first and second temperature sensors is defective. For example, if the temperature detected by one of the temperature sensors is changing, but the temperature detected by the other temperature sensor is not changing or is changing at a lower rate of change (taking into account expected differences between the upstream and downstream temperatures), then the processor 150 may determine that one of the temperature sensors is defective.

### Method of Determining Whether Intensity Sensor is Defective

A method of operating a system 100 for treating a fluid that flows through the reactor 102 and is exposed to UV light emitted from a UV light source assembly 120 includes detecting, with an intensity sensor 127, an intensity of UV light emitted by the UV light source assembly 120, detecting, with the temperature sensor 126, a temperature in the UV light source assembly 120, and determining, by at least one processor 150, that the intensity sensor 127 is defective based on the detected intensity of UV light and the detected temperature in the UV light source assembly 120.

When the UV light source assembly 120, e.g., the LED array 124, is turned on (e.g., when electric power is supplied to the light source assembly from a power source), the temperature detected by the temperature sensor 126 may increase, for example, due to heat generated by the light source assembly 120 and/or the LED array 124. After turning on the light source assembly 120, the processor 150 may monitor the temperature detected by the temperature sensor 126 for a corresponding increase in temperature to confirm power supply to the light source assembly 120. The processor 150 may receive the temperature detected by the temperature sensor 126 and compare the detected temperature to a threshold temperature value. The threshold value may be a previous temperature value, e.g., in a state immediately before turning on the light source assembly 120, or the threshold temperature value may be indicative of a temperature in the light source assembly during a state in which the light source assembly is turned off. In the latter case, for example, the threshold value may be set based on the fluid temperature, reactor 102 temperature, ambient temperature, and/or any other relevant consideration in a state in which the light source assembly 120 is powered off. The threshold value may be periodically or otherwise updated (e.g., upon occurrence of a trigger, such as a change in fluid, reactor 102 temperature, and/or ambient temperature) by the processor 150. If the detected temperature is greater than the threshold temperature value, then the processor 150 may confirm power supply to the light source assembly 120.

The processor 150 may further determine a temperature parameter based on the detected temperature, such as a change in temperature, a rate of temperature, and/or an absolute temperature value, as discussed above. When power is supplied to the light source assembly 120, the temperature in the light source assembly 120 may change by an amount greater than a temperature change during a state in which the light source assembly 120 is powered off. For example, temperature changes during the state in which the light source assembly 120 is powered off may be due to changes in one or more of fluid temperature, reactor 102 temperature, ambient temperature, and the like. Changes in the temperature in the light source assembly 120 in the powered off state may be not only be less than the change in temperature upon turning on the light source assembly 120, but also may be more gradual than the change in temperature upon turning on the light source assembly 120. Thus, the amount of change and the rate of change in temperature due to the supply of power to the light source assembly 120 may be higher than the amount and rate of change of in temperature of the light source assembly 120 in a powered off state.

Therefore, the processor 150 may alternatively or additionally compare the temperature parameter to a threshold temperature parameter value. In this case, the threshold value may be a previous temperature parameter (e.g., determined based on a detected temperature in a state immediately before turning on the light source assembly 120) or the threshold value maybe otherwise indicative of an absolute temperature value, a change in temperature, and/or a rate of change in temperature during a state in which the light source assembly is turned off. In the latter case, for example, the threshold value may be set based on the absolute temperature value, change in temperature and/or rate of change in temperature of the fluid, reactor 102, and/or atmosphere in which the reactor 102 is arranged during a state in which the light source assembly 120 is powered off, and/or any other relevant consideration. For example, the threshold value may be periodically or otherwise updated based on changes in fluid temperature, reactor 102 temperature, and/or ambient temperature, and/or any other relevant consideration. If one or more of the temperature parameters is greater than the threshold value, then the processor 150 may confirm power supply to the light source assembly 120.

When the light source assembly 120, for example, the LED array 124, is turned on, an intensity of UV light detected by the intensity sensor 127 should also increase. The processor 150 may compare the intensity of UV light detected by the intensity sensor 127 after the light source assembly 120 has been powered on to a threshold intensity. The threshold intensity may be a previous intensity value, e.g., in a state immediately before turning on the light source assembly 120, or the threshold intensity value may be otherwise indicative of an intensity value of the UV light during a state in which the light source assembly is turned off. The threshold intensity value may be substantially 0 or may be a value that is nominally above 0. Alternatively, the threshold value may be a low intensity value that is lower than the intensity of UV light that should be emitted upon turning on the light source assembly 120. For example, the threshold intensity may be a value in a range of 0 to 50%, 0.5 to 25%, or 1 to 10% of a maximum or expected intensity value of the UV light when the light source assembly is powered on. The threshold intensity may be set based on the amount of power supplied to the light source assembly 120. For example, the threshold intensity may be set as a percentage (e.g., within one of the above percentage ranges) of the expected intensity based on the amount of power supplied to the light source assembly 120. If the detected intensity is greater than the threshold temperature value, then the processor 150 may confirm power supply to the light source assembly 120.

The processor 150 may determine that the intensity sensor 127 is defective if the detected temperature and/or temperature parameter determined by the processor 150 indicates that the light source assembly 120, for example, the LED array 124 is powered on, but the intensity of UV light detected by the intensity sensor 127 does not show a corresponding increase. For example, the processor 150 may determine that the intensity sensor 127 is defective if (i) the detected temperature and/or the temperature parameter exceeds the threshold value and (ii) the intensity of UV light detected by the intensity sensor 127 is equal to or below threshold intensity.

If the processor 150 determines that the intensity sensor 127 is defective, the processor 150 may control the power supplied to the light source assembly 120 to set the power to a maximum power level rather than requiring a system shut down, for example. The processor 150 may output a notification signal, such as a visual indicator, test, a sound, or any other suitable notification signal. The notification signal may indicate that the intensity sensor 127 may be defective. The intensity sensor 127 may then be serviced and fixed or replaced.

It will be appreciated that the above-disclosed features and functions, or alternatives thereof, may be desirably combined into different systems and methods. Also, various alternatives, modifications, variations or improvements may be subsequently made by those skilled in the art, and are also intended to be encompassed by the disclosed embodiments. As such, various changes may be made without departing from the spirit and scope of this disclosure.

What is claimed is:

1. A method of operating a system for treating a fluid that flows through a reactor and is exposed to ultraviolet (UV) light emitted from a UV light source assembly, the method comprising:
detecting, with a flow sensor, a flow rate of the fluid through the reactor; and
controlling, with at least one processor, electric power supplied to the UV light source assembly so that: (i) an amount of the electric power is adjusted based on the detected flow rate in a first state in which the detected flow rate is greater than or equal to a threshold flow rate, and (ii) a low average amount of electric power is supplied to the UV light source assembly in a second state in which the detected flow rate is below the threshold flow rate, wherein the low average amount has a non-zero value that is not based on the detected flow rate and is lower than the amount of electric power supplied in the first state over a given time.

2. The method according to claim 1, wherein the at least one processor controls the electric power through pulse width modulation in the second state.

3. The method according to claim 1, wherein the at least one processor controls the electric power so that the low average amount of electric power supplied to the UV light source assembly in the second state is at least 5% of a maximum amount of electric power that can be supplied to the UV light source assembly.

4. The method according to claim 1, wherein the at least one processor adjusts the amount of the electric power in a stepwise manner proportionally to the detected flow rate in the first state, and wherein the low average amount of the electric power supplied to the UV light source assembly in the second state is not proportional to the detected flow rate.

5. A method of operating a system for treating a fluid that flows through a reactor and is exposed to ultraviolet (UV) light emitted from a UV light source assembly, the method comprising:
detecting, with at least one temperature sensor, a temperature in the UV light source assembly; and
controlling, with at least one processor, an intensity of the UV light based on the detected temperature from the at least one temperature sensor.

6. The method of claim 5, further comprising determining, with the at least one processor, a temperature parameter that is at least one of change in the detected temperature, a rate of change in the detected temperature, and an absolute temperature value.

7. The method of claim 6, wherein the at least one processor controls the intensity of the UV light based on the determined temperature parameter.

8. The method of claim 5, wherein the at least one processor controls the intensity of the UV light by controlling electrical power supplied to the UV light source assembly.

9. The method of claim 6, further comprising:
detecting, with a flow sensor, a flow rate of the fluid through the reactor; and
determining, by the at least one processor, that the flow sensor is defective if (i) the temperature parameter is outside of a predetermined range; and (ii) the flow rate detected by the flow sensor is below a threshold flow rate.

10. The method of claim 9, further comprising:
determining if the temperature parameter is outside of the predetermined range; and
if the temperature parameter is outside of the predetermined range and if power to the UV light source assembly is off or in a low power mode, then increasing the power to the UV light source assembly to expose the fluid to the UV light.

11. The method of claim 9, further including:
sending a notification signal, by the at least one processor, including at least one of a visual indicator, text, and a sound if the at least one processor determines that the flow sensor is defective.

12. The method of claim 5, further comprising determining, by the at least one processor, a flow rate of the fluid based on the detected temperature.

13. The method of claim 5, further comprising detecting, with at least one fluid temperature sensor, a temperature of the fluid, and wherein the at least one processor further controls the intensity of the UV light based on the detected fluid temperature.

14. The method of claim 5, wherein:
the at least one temperature sensor includes a first temperature sensor located at a relatively upstream position with respect to the flow of the fluid and a second temperature sensor located at a relatively downstream position with respect to the flow of the fluid.

15. The method of claim 14, further comprising comparing, by the at least one processor, a temperature detected by the first temperature sensor and a temperature detected by the second temperature sensor, and determining that one of the first temperature sensor and the second temperature sensor are defective based on the comparison.

16. A method of operating a system for treating a fluid that flows through a reactor and is exposed to ultraviolet (UV) light emitted from a UV light source assembly, the method comprising:
detecting, with at least one temperature sensor, a temperature in the UV light source assembly;
detecting, with a flow sensor, a flow rate of the fluid through the reactor; and
determining, by at least one processor, that the flow sensor is defective based on the detected temperature and the detected flow rate.

17. The method of claim 16, further comprising determining, with the at least one processor, a temperature parameter that is at least one of a change in the detected temperature and a rate of change in the detected temperature, and wherein the at least one processor determines that the flow sensor is defective if (i) the temperature parameter exceeds a threshold value; and (ii) the flow rate measured by the flow sensor is below a threshold flow rate.

18. The method of claim 16, further comprising controlling, with the at least one processor, an intensity of the UV light based on the detected temperature from the at least one temperature sensor after the processor determines that the flow sensor is defective.

19. A method of operating a system for treating a fluid that flows through a reactor and is exposed to ultraviolet (UV) light emitted from a UV light source assembly, the method comprising:
detecting, with an intensity sensor, an intensity of UV light emitted by the UV light source assembly;
detecting, with a temperature sensor, a temperature in the UV light source assembly; and
determining, by at least one processor, that the intensity sensor is defective based on the detected intensity of UV light and the detected temperature in the UV light source assembly.

20. The method of claim 19, further comprising determining, with the at least one processor, a temperature parameter that is at least one of a change in the detected temperature, a rate of change in the detected temperature, and an absolute temperature value, and wherein the at least one processor determines that the intensity sensor is defective if (i) the temperature parameter exceeds a threshold value; and (ii) the intensity of UV light detected by the intensity sensor is equal to or less than a threshold intensity.
